(19) United States
(12) Patent Application Publication
(10) Pub. No.: US 2010/0074350 A1
(43) Pub. Date: Mar. 25, 2010

(54) CODEWORD LEVEL SCRAMBLING FOR MIMO TRANSMISSION

(75) Inventors: Durga Prasad Malladi, San Diego, CA (US); Juan Montojo, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/444,510

(22) PCT Filed: Nov. 6, 2007
(86) PCT No.: PCT/US07/83730

§ 371 Date: Oct. 6, 2009

Related U.S. Application Data
(60) Provisional application No. 60/864,582, filed on Nov. 6, 2006.

(51) Int. Cl. H04L 27/28; H04L 27/00; H04L 27/06

(52) U.S. Cl. 375/260; 375/295; 375/340

(57) ABSTRACT

Techniques for performing codeword level scrambling for a MIMO transmission are described. A transmitter station may perform channel encoding for multiple data streams being sent simultaneously for a MIMO transmission. The channel encoding may include forward error correction (FEC) encoding and/or rate matching. The transmitter station may perform scrambling for the multiple data streams with different scrambling codes after the channel encoding. The transmitter station may also perform channel interleaving, symbol mapping, and spatial processing for the multiple data streams after the channel encoding. A receiver station may receive the MIMO transmission, perform descrambling for the multiple data streams with the different scrambling codes, and then perform channel decoding for the multiple data streams. The scrambling may allow the receiver station to isolate each data stream by performing the complementary descrambling and to obtain randomized interference from the remaining data stream(s), which may improve performance.

The present application claims priority to provisional U.S. Application Ser. No. 60/864,582, entitled “A METHOD AND APPARATUS FOR CODEWORD LEVEL SCRAMBLING IN MIMO OPERATION,” filed Nov. 6, 2006, assigned to the assignee hereof and incorporated herein by reference.

### BACKGROUND

I. Field

The present disclosure relates generally to communication, and more specifically to techniques for transmitting data in a wireless communication system.

II. Background

Wireless communication systems are widely deployed to provide various communication content such as voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may support multiple-input multiple-output (MIMO) transmission. For MIMO, a transmitter station may send multiple data streams simultaneously via multiple transmit antennas to multiple receive antennas at a receiver station. The multiple transmit and receive antennas form a MIMO channel that may be used to increase throughput and/or improve reliability. For example, S data streams may be sent simultaneously from S transmit antennas to improve throughput.

Due to scattering in the wireless channel between the transmitter and receiver stations, the multiple data streams sent simultaneously by the transmitter station typically interfere with one another at the receiver station. It is thus desirable to transmit the multiple data streams in a manner to facilitate their reception at the receiver station.

### SUMMARY

Techniques for performing codeword level scrambling for a MIMO transmission in a wireless communication system are described herein. Codeword level scrambling refers to scrambling after channel encoding at a transmitter station, which may be a Node B or a user equipment (UE). In general, one or more transmitter stations may send multiple data streams simultaneously for a MIMO transmission to one or more receiver stations. Each data stream may be scrambled with a different scrambling code after channel encoding by a transmitter station for that data stream. The scrambling may allow a receiver station for a given data stream to isolate that data stream by performing the complementary descrambling and to obtain randomized interference from the remaining data stream(s). These characteristics may be beneficial in a scenario in which the multiple data streams may not be spatially separable and may improve performance.

In one design, a transmitter station (e.g., a Node B or a UE) may perform channel encoding for multiple data streams being sent simultaneously for a MIMO transmission. The channel encoding may comprise forward error correction (FEC) encoding (e.g., Turbo or convolutional encoding) and/or rate matching (e.g., puncturing or repetition). The transmitter station may perform scrambling for the multiple data streams with multiple scrambling codes after the channel encoding. The transmitter station may also perform channel interleaving, symbol mapping, and spatial processing for the multiple data streams after the channel encoding.

In one design, a receiver station may receive the MIMO transmission comprising the multiple data streams and may perform MIMO detection to obtain multiple detected symbol streams. The receiver station may perform symbol demapping and channel deinterleaving on the detected symbol streams. The receiver station may also perform descrambling for the multiple data streams with different scrambling codes and may then perform channel decoding (e.g., FEC decoding and/or de-rate matching) for the multiple data streams.

Various aspects and features of the disclosure are described in further detail below.

### BRIEF DESCRIPTION OF THE DRAWINGS

FIG. 1 shows a wireless communication system.

FIG. 2A shows single-user MIMO (SU-MIMO) for the downlink.

FIG. 2B shows multi-user MIMO (MU-MIMO) for the downlink.

FIG. 2C shows MU-MIMO for the uplink.

FIG. 3 shows a block diagram of one Node B and two UEs.

FIG. 4A shows a transmit (TX) data processor for multiple data streams.

FIG. 4B shows a TX data processor for one data stream.

FIG. 5A shows a receive (RX) data processor for multiple data streams.

FIG. 5B shows an RX data processor for one data stream.

FIG. 6 shows a process for transmitting multiple data streams.

FIG. 7 shows an apparatus for transmitting multiple data streams.

FIG. 8 shows a process for transmitting one data stream.

FIG. 9 shows an apparatus for transmitting one data stream.

FIG. 10 shows a process for receiving multiple data streams.

FIG. 11 shows an apparatus for receiving multiple data streams.

FIG. 12 shows a process for receiving one data stream.

FIG. 13 shows an apparatus for receiving one data stream.

### DETAILED DESCRIPTION

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.16 (WiMAX), IEEE 802.20, Flash-OFDM®, etc. UTRA, E-UTRA and GSM are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, GSM, UMTS and LTE are described in documents from an organization named “3rd Generation Partnership Project” (3GPP). cdma2000 and UMB are described in documents from an organization named “3rd Generation Partnership Project 2” (3GPP2). The techniques may also be used for wireless local area networks (WLANs), which may implement a radio technology such as IEEE 802.11 (Wi-Fi), Hiperlan, etc. These various radio technologies and standards are known in the art.

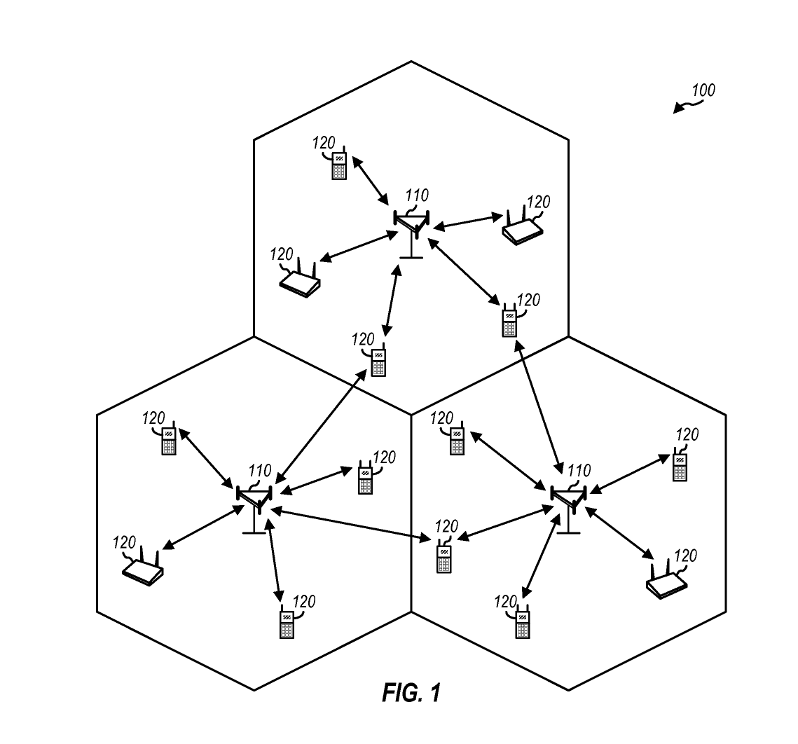

FIG. 1 shows a wireless communication system 100 with multiple Node Bs 110. A Node B may be a fixed station used for communicating with the UEs and may also be referred to as an evolved Node B (eNB), a base station, an access point, etc. Each Node B 110 provides communication coverage for a particular geographic area. UEs 120 may be dispersed throughout the system. A UE may be stationary or mobile and may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, etc. A UE may communicate with a Node B via transmission on the downlink and uplink. The downlink (or forward link) refers to the communication link from the Node Bs to the UEs, and the uplink (or reverse link) refers to the communication link from the UEs to the Node Bs.

System 100 may support MIMO transmission on the downlink and/or uplink. On the downlink, a Node B may send a MIMO transmission to either a single UE for SU-MIMO or multiple UEs for MU-MIMO. On the uplink, the Node B may receive a MIMO transmission from either a single UE for SU-MIMO or multiple UEs for MU-MIMO. MU-MIMO is also commonly referred to as Spatial Division Multiple Access (SDMA).

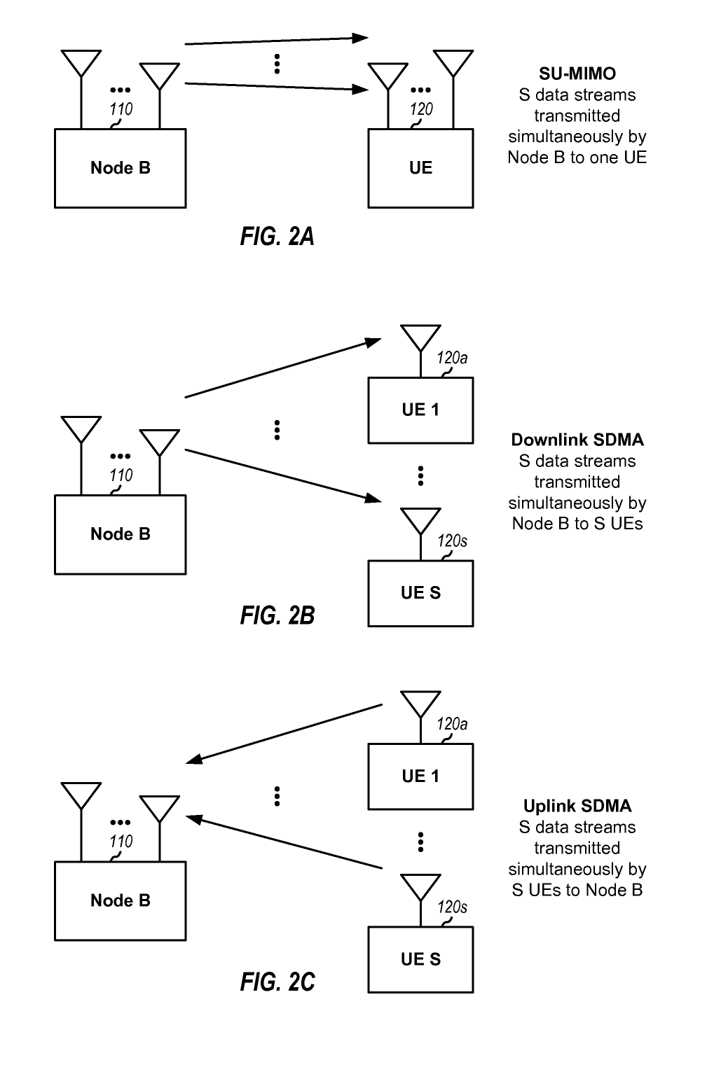

FIG. 2A shows MIMO transmission on the downlink for SU-MIMO. A Node B 110 may send a MIMO transmission comprising multiple (S) data streams to a single UE 120 on a set of resources. UE 120 may receive the MIMO transmission with S or more antennas and may perform MIMO detection to recover each data stream.

MIMO transmission on the uplink for SU-MIMO may occur in similar manner. UE 120 may send a MIMO transmission comprising multiple data streams to Node B 110 on a set of resources. Node B 110 may perform MIMO detection to recover the data streams sent by UE 120.

FIG. 2B shows MIMO transmission on the downlink for SDMA. Node B 110 may send a MIMO transmission comprising S data streams to S different UEs 120a through 120s on a set of resources. Node B 110 may perform precoding or beamforming to steer each data stream to the recipient UE. In this case, each UE may be able to receive its data stream with a single antenna, as shown in FIG. 2B. Node B 110 may also transmit the S data streams from S antennas, one data stream from each antenna. In this case, each UE 120 may receive the MIMO transmission with multiple antennas (not shown in FIG. 2B) and may perform MIMO detection to recover its data stream in the presence of interference from the other data stream(s). In general, Node B 110 may send one or more data streams to each UE for SDMA, and each UE may recover its data stream(s) with a sufficient number of antennas.

FIG. 2C shows MIMO transmission on the uplink for SDMA. S different UEs 120a through 120s may send S data streams simultaneously on a set of resources to Node B 110. Each UE 120 may transmit its data stream from one antenna, as shown in FIG. 2C. Node B 110 may receive the MIMO transmission from the S UEs 120a through 120s with multiple antennas and may perform MIMO detection to recover the data stream from each UE in the presence of interference from the other data stream(s). In general, each UE 120 may send one or more data streams to Node B 110 for SDMA, and Node B 110 may recover the data streams from all UEs with a sufficient number of antennas.

In general, one or more transmitter stations may send a MIMO transmission to one or more receiver stations. For the downlink, one transmitter station or Node B may send a MIMO transmission to one or more receiver stations or UEs. On the uplink, one or more transmitter stations or UEs may send a MIMO transmission to one receiver station or Node B. A transmitter station may thus be a Node B or a UE and may send one or multiple data streams for a MIMO transmission. A receiver station may also be a Node B or a UE and may receive one or multiple data streams in a MIMO transmission.

In general, a data stream may carry any type of data and may be encoded independently by a transmitter station. A data stream may then be decoded independently by a receiver station. A data stream may also be referred to as a spatial stream, a symbol stream, a stream, a layer, etc. Encoding is typically performed on a block of data to obtain an encoded block of data. A data block may also be referred to as a code block, a transport block, a packet, a protocol data unit (PDU), etc. An encoded block may also be referred to as a codeword, a coded packet, etc. Multiple data blocks in multiple data streams may be encoded to obtain multiple codewords, which may then be sent in parallel in a MIMO transmission. Thus, the terms “stream”, “data stream”, “codeword”, and “layer” may be used interchangeably.

The number of data streams that can be sent simultaneously via a MIMO channel and successfully decoded by the receiver station(s) is commonly referred to as the rank of the MIMO channel. The rank may be dependent on various factors such as the number of transmit antennas, the number of receive antennas, the channel conditions, etc. For example, if the signal paths for different transmit-receive antenna pairs are correlated, then fewer data streams (e.g., one data stream) may be supported since sending more data streams may result in each data stream observing excessive interference from the other data stream(s). The rank may be determined based on the channel conditions and other applicable factors in various manners known in the art. The number of data streams to send may then be limited by the rank.

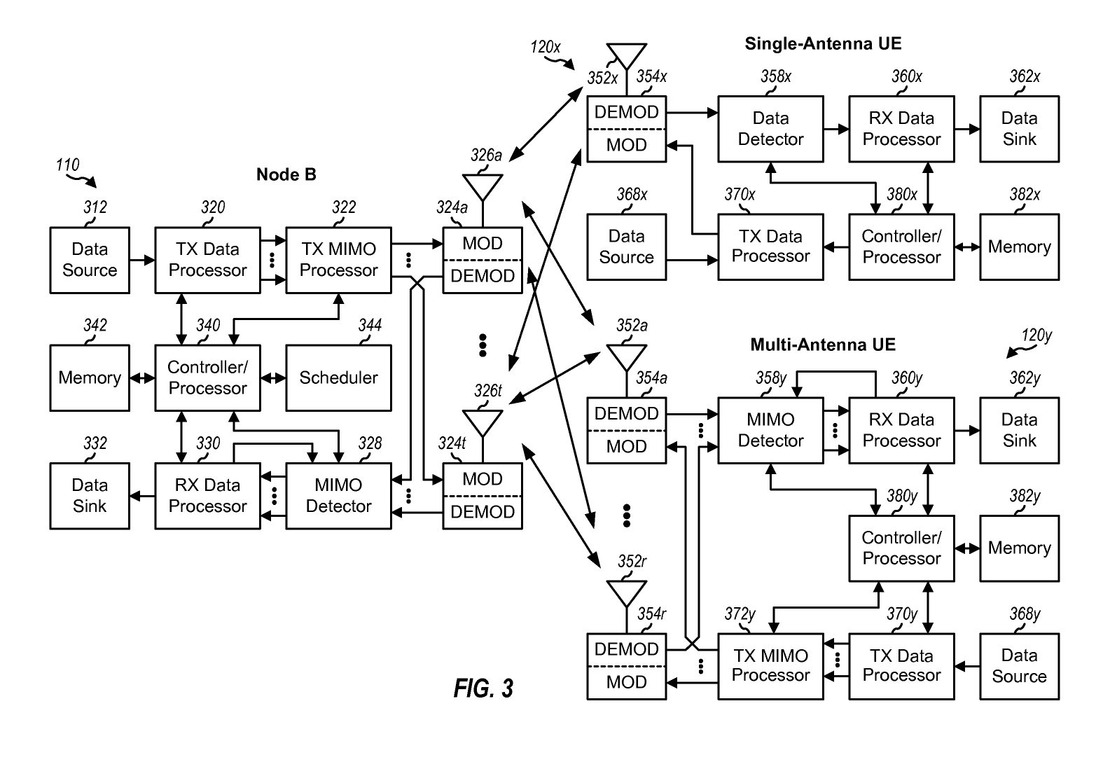

FIG. 3 shows a block diagram of one Node B 110 and two UEs 120x and 120y. Node B 110 is equipped with multiple (T) antennas 326a through 326t. UE 120x is equipped with a single antenna 352x. UE 120y is equipped with multiple (R) antennas 352a through 352r. Each antenna may be a physical antenna or an antenna array.

At Node B 110, a TX data processor 320 may receive data from a data source 312 for one or more UEs being served. TX data processor 320 may process (e.g., encode, interleave, and symbol map) the data for each UE based on one or more modulation and coding schemes selected for that UE to obtain data symbols. A modulation and coding scheme may also be referred to as a packet format, a transport format, a rate, etc. TX data processor 320 may also generate and multiplex pilot symbols with the data symbols. A data symbol is a symbol for data, a pilot symbol is a symbol for pilot, and a symbol is typically a complex value. The data and pilot symbols may be modulation symbols from a modulation scheme such as PSK or QAM. Pilot is data that is known a priori by both the Node B and the UEs.

A TX MIMO processor 322 may perform spatial processing on the data and pilot symbols from TX data processor 320. TX MIMO processor 322 may perform direct MIMO mapping, precoding/beamforming, etc. A data symbol may be sent from one antenna for direct MIMO mapping or from multiple antennas for precoding/beamforming. TX MIMO processor 322 may provide T output symbol streams to T modulators (MOD) 324a through 324t. Each modulator 324 may process its output symbol stream (e.g., for orthogonal frequency division multiplexing (OFDM), etc.) to obtain an output chip stream. Each modulator 324 may further condition (e.g., convert to analog, filter, amplify, and upconvert) its output chip stream and generate a downlink signal. T downlink signals from modulators 324a through 324t may be transmitted from T antennas 326a through 326t, respectively.

At each UE 120, one or multiple antennas 352 may receive the downlink signals from Node B 110. Each antenna 352 may provide a received signal to an associated demodulator (DEMOD) 354. Each demodulator 354 may condition (e.g., filter, amplify, downconvert, and digitize) its received signal to obtain samples and may further process the samples (e.g., for OFDM) to obtain received symbols.

At single-antenna UE 120x, a data detector 358x may perform data detection (e.g., matched filtering or equalization) on the received symbols from demodulator 354x and provide detected symbols, which are estimates of the transmitted data symbols. An RX data processor 360x may process (e.g., symbol demap, deinterleave, and decode) the detected symbols to obtain decoded data, which may be provided to a data sink 362x. At multi-antenna UE 120y, a MIMO detector 358y may perform MIMO detection on the received symbols from demodulators 354a through 354r and provide detected symbols. An RX data processor 360y may process the detected symbols to obtain decoded data, which may be provided to a data sink 362y.

UEs 120x and 120y may transmit data on the uplink to Node B 110. At each UE 120, data from a data source 368 may be processed by a TX data processor 370 and further processed by a TX MIMO processor 372 (if applicable) to obtain one or more output symbol streams. One or more modulators 354 may process the one or more output symbol streams (e.g., for single-carrier frequency division multiplexing (SC-FDM), etc.) to obtain one or more output chip streams. Each modulator 354 may further condition its output chip stream to obtain an uplink signal, which may be transmitted via an associated antenna 352. At Node B 110, the uplink signals from UE 120x, UE 120y and/or other UEs may be received by antennas 326a through 326t, conditioned and processed by demodulators 324a through 324t, and further processed by a MIMO detector 328 and an RX data processor 330 to recover the data sent by the UEs.

Controllers/processors 340, 380x and 380y may direct the operation at Node B 110 and UEs 120x and 120y, respectively. Memories 342, 382x and 382y may store data and program codes for Node B 110 and UEs 120x and 120y, respectively. A scheduler 344 may schedule UEs for downlink and/or uplink transmission and may provide assignments of resources for the scheduled UEs.

In general, a MIMO transmission comprising multiple (S) data streams may be sent on any resources. The resources may be quantified by time (in most systems), by frequency (e.g., in OFDMA and SC-FDMA systems), by code (e.g., in CDMA system), by some other quantity, or by any combination thereof. Since the multiple data streams are transmitted on the same resources, an assumption may be made that these data streams are spatially separable at the receiver station(s). However, there may be instances in which the data streams may not be spatially separable, e.g., because the available rank information is stale or incorrect and/or because of other reasons. In such instances, it may be desirable to have a transmission structure that allows the receiver station(s) to differentiate the data streams.

In an aspect, each data stream in a MIMO transmission may be individually scrambled with a scrambling code after channel encoding by a transmitter station for that data stream. The S data streams in the MIMO transmission may be scrambled with S different scrambling codes. The scrambling codes may be pseudo-random number (PN) sequences or some other type of codes or sequences. The S scrambling codes may be pseudo-random with respect to one another. A receiver station designated to receive a given data stream may perform the complementary descrambling with the scrambling code used for that data steam. The receiver station would then be able to isolate the desired data stream while the remaining data stream(s) would appear as pseudo-random noise. Each data stream may thus be differentiated by its receiver station based on the scrambling code for that data stream.

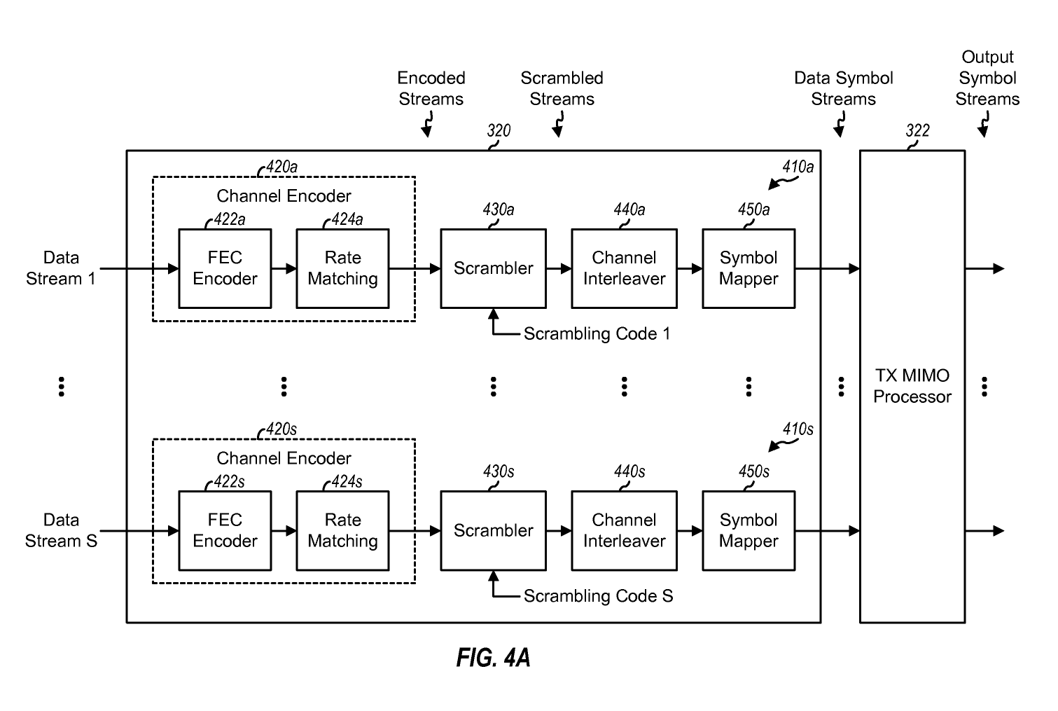

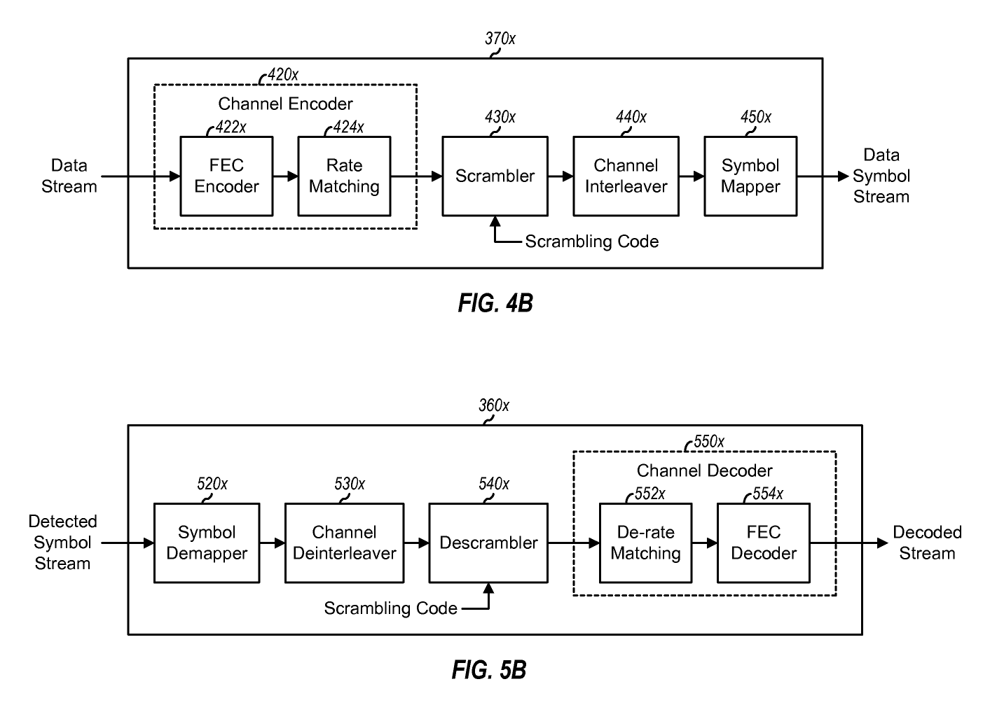

FIG. 4A shows a block diagram of a design of TX data processor 320 at Node B 110, which may also be used for TX data processor 370y at UE 120y in FIG. 3. In this design, RX data processor 320 includes S processing sections 410a through 410s for S data streams to be sent in parallel for a MIMO transmission, where S may be any integer value greater than one. Each processing section 410 may receive and process one data stream and provide a corresponding data symbol stream.

Within processing section 410a for data stream 1, which may carry one or more data blocks, a channel encoder 420a may encode each data block in data stream 1 and provide a corresponding codeword. Channel encoder 420a may include an FEC encoder 422a and a rate matching unit 424a. FEC encoder 422a may encode each data block in accordance with a coding scheme selected for data stream 1. The selected coding scheme may include a convolutional code, a Turbo code, a low density parity check (LDPC) code, a cyclic redundancy check (CRC) code, a block code, no coding, etc. FEC encoder 422a may have a fixed code rate of 1/Q and may encode a data block of N information bits and provide an encoded block of Q·N code bits. Unit 424a may perform rate matching on the code bits generated by FEC encoder 422a to obtain the desired number of code bits. Unit 424a may puncture (or delete) some code bits if the desired number of code bits is less than the number of generated code bits. Alternatively, unit 424a may repeat some code bits if the desired number of code bits is greater than the number of generated code bits. In general, channel encoder 420a may perform only FEC encoding, or only rate matching (e.g., repetition), or both FEC encoding and rate matching (e.g., either puncturing or repetition) on a data block and provide a codeword. Channel encoder 420a provides an encoded stream with one or more codewords.

A scrambler 430a may scramble the encoded stream from channel encoder 420a with a scrambling code for data stream 1 and provide a scrambled stream. The scrambling code may be generated in various manners. In one design, a linear feedback shift register (LFSR) may be used to implement a generator polynomial for a PN sequence. The output of the LFSR is a pseudo-random bit sequence that may be used as the scrambling code. The S scrambling codes for the S data streams may be S different PN sequences, which may be obtained with S different seed values for the LFSR (in which case the S PN sequences are essentially one PN sequence at different offsets) or S different generator polynomials. The S scrambling codes may also be generated in other manners. In any case, the S scrambling codes may be pseudo-random with respect to one another. Scrambler 430a may scramble the encoded stream by multiplying each code bit in the encoded stream with one bit of the scrambling code to obtain a scrambled bit.

A channel interleaver 440a may receive the scrambled stream from scrambler 430a, interleave or reorder the scrambled bits based on an interleaving scheme, and provide an interleaved stream. The channel interleaving may be performed separately for each data stream (as shown in FIG. 4A) or across some or all S data streams (not shown in FIG. 4A). The channel interleaving may also be omitted. A symbol mapper 450a may receive the interleaved bits from channel interleaver 440a and may map the interleaved bits to data symbols based on a modulation scheme selected for data stream 1. The symbol mapping may be performed by (i) grouping sets of B bits to form B-bit values, where B≧1, and (ii) mapping each B-bit value to one of 2^{B} points in a signal constellation for the selected modulation scheme. Each mapped signal point is a complex value for a data symbol. Symbol mapper 450a provide a data symbol stream for data stream 1.

Each remaining processing section 410 within TX data processor 320 may similarly process its data stream and provide a corresponding data symbol stream. Processing sections 410a through 410s may provide S data symbol streams to TX MIMO processor 322.

TX MIMO processor 322 may perform spatial processing on the S data symbol streams in various manners. For direct MIMO mapping, TX MIMO processor 322 may map the S data symbol streams to S transmit antennas, one data symbol stream to each transmit antenna. In this case, each data stream is essentially sent via a different transmit antenna. For precoding, TX MIMO processor 322 may multiply the data symbols in the S streams with a precoding matrix such that each data symbol is sent from all T transmit antennas. In this case, each data stream is essentially sent via a different “virtual” antenna formed by one column of the precoding matrix and the T transmit antennas. TX MIMO processor 322 may also perform spatial processing on the S data symbol streams in other manners.

Node B 110 may perform spatial processing jointly for the S data streams for downlink SDMA. Each UE 120 may perform spatial processing individually for its data stream(s) for uplink SDMA.

FIG. 4B shows a block diagram of a design of TX data processor 370x at single-antenna UE 120x in FIG. 3. TX data processor 370x may receive a data stream to be sent simultaneously with one or more other data streams from one or more other UEs for a MIMO transmission on the uplink. TX data processor 370x may process the data stream and provide a corresponding data symbol stream. Within TX data processor 370x, a channel encoder 420x may encode each data block in the data stream and provide a corresponding codeword. Within channel encoder 420x, an FEC encoder 422x may encode each data block in accordance with a selected coding scheme, and a rate matching unit 424x may either puncture or repeat some code bits to obtain the desired number of code bits. A scrambler 430x may scramble the encoded stream from channel encoder 420x with a scrambling code for the data stream and provide a scrambled stream. A channel interleaver 440x may interleave the bits in the scrambled stream based on an interleaving scheme. A symbol mapper 450x may map the interleaved bits to data symbols based on a selected modulation scheme and provide the data symbol stream.

FIGS. 4A and 4B show designs in which the scrambling is performed immediately after the channel encoding. In general, the scrambling may be performed at various locations after the channel encoding. For example, the scrambling may be performed after the channel interleaving, after the symbol mapping, etc.

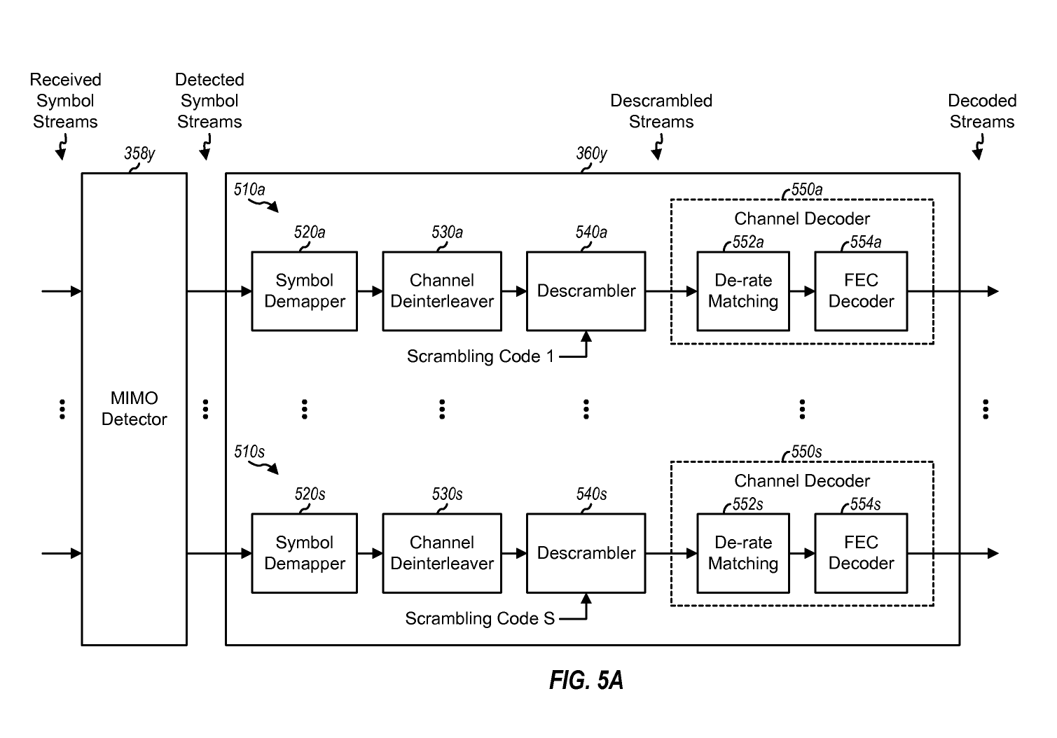

FIG. 5A shows a block diagram of a design of RX data processor 360y at UE 120y, which may also be used for RX data processor 330 at Node B 110 in FIG. 3. RX data processor 360y may recover all or a subset of the S data streams sent in a MIMO transmission. For simplicity, FIG. 5A shows RX data processor 360y processing all S data streams sent in the MIMO transmission.

MIMO detector 358y may obtain R received symbol streams from R demodulators 354a through 354r. MIMO detector 358y may perform MIMO detection on the R received symbol streams based on minimum mean square error (MMSE), zero-forcing, or some other techniques. MIMO detector 358y may provide S detected symbol streams, which are estimates of the S data symbol streams.

In the design shown in FIG. 5A, RX data processor 360y includes S processing sections 510a through 510s for the S data streams. Each processing section 510 may receive and process one detected symbol stream and provide a corresponding decoded data stream. Within processing section 510a for data stream 1, a symbol demapper 520a may perform symbol demapping on its detected symbol stream. Symbol demapper 520a may compute log-likelihood ratios (LLRs) for the code bits transmitted for data stream 1 based on the detected symbols and the modulation scheme used for data stream 1. A channel deinterleaver 530a may deinterleave the LLRs in a manner complementary to the interleaving by channel interleaver 440a at Node B 110 in FIG. 4A. A descrambler 540a may descramble the deinterleaved LLRs with the scrambling code used for data stream 1 and provide a descrambled stream.

A channel decoder 550a may decode the LLRs in the descrambled stream and provide a decoded data stream with one or more decoded data blocks. Channel decoder 550a may include a de-rate matching unit 552a and an FEC decoder 554a. Unit 552a may insert erasures for code bits that have been deleted by rate matching unit 424a at Node B 110 in FIG. 4A. An erasure may be an LLR value of 0, which indicates equal likelihood of a ‘0 ’ or ‘1 ’ being transmitted for a code bit. Unit 552a may also combine LLRs for code bits that have been repeated by rate matching unit 424a. Unit 552a may provide LLRs for all code bits generated by FEC encoder 422a at Node B 110. FEC decoder 554a may perform decoding on the LLRs from unit 552a in a manner complementary to the encoding performed by FEC encoder 422a. For example, FEC decoder 554a may perform Turbo or Viterbi decoding if Turbo or convolutional coding, respectively, is performed by FEC encoder 422a.

Each remaining processing section 510 within RX data processor 360y may similarly process its detected symbol stream and provide a corresponding decoded data stream. Processing sections 510a through 510s may provide S decoded data streams, which are estimates of the S data streams sent in the MIMO transmission.

MIMO detector 358y may be able to spatially separate the S data streams sent in parallel for the MIMO transmission. In this case, the detected symbol stream for each data stream may observe little interference from the other data stream(s). However, the S data streams may have poor spatial separation, in which case the detected symbol stream for each data stream may observe more interference from the other data stream(s). The descrambling by each descrambler 540 may randomize the interference from the other data stream(s), which may improve channel decoding for the data stream being recovered.

MIMO detector 358y and RX data processor 360y may also perform successive interference cancellation. In this case, MIMO detector 358y may initially perform MIMO detection on the received symbol streams and provide one detected symbol stream for one data stream. RX data processor 360y may process the detected symbol stream and provide a decoded data stream, as described above. The interference from the decoded data stream may be estimated and subtracted from the received symbol streams. MIMO detection and RX data processing may then be repeated for the next data stream. The scrambling and descrambling for each data stream may improve performance for successive interference cancellation, e.g., by ensuring that the inter-stream interference is white even in the presence of repetition of coded bits in a given stream.

FIG. 5B shows a block diagram of a design of RX data processor 360x at UE 120x. RX data processor 360x may receive a detected symbol stream for one data stream from data detector 358x. This data stream may be one of multiple data streams sent in parallel for a MIMO transmission to multiple UEs. Within RX data processor 360x, a symbol demapper 520x may perform symbol demapping on the detected symbol stream and provide LLRs for the transmitted code bits. A channel deinterleaver 530x may deinterleave the LLRs. A descrambler 540x may descramble the deinterleaved LLRs with the scrambling code used for the data stream and provide a descrambled stream. A channel decoder 550x may decode the LLRs in the descrambled stream and provide a decoded data stream. Within channel decoder 550x, a de-rate matching unit 552x may insert erasures for code bits that have been deleted and may combine LLRs for code bits that have been repeated. An FEC decoder 554x may perform decoding on the LLRs from unit 552x and provide a decoded data block for each codeword.

FIGS. 5A and 5B show designs in which the descrambling is performed immediately before the channel decoding. In general, the descrambling may be performed at a location determined by the scrambling at a transmitter station. For example, the descrambling may be performed before the channel deinterleaving, before the symbol demapping, etc.

In general, the scrambling may be performed independently for each data stream so that a receiver station can isolate the data stream by performing the complementary descrambling. The scrambling allows the different data streams to be distinguished even if they carry identical data. The scrambling may be performed after the channel encoding so that randomized interference from other data stream(s) can be provided to the channel decoder at the receiver station.

The ability to differentiate between the multiple data streams sent in a MIMO transmission may be beneficial for various reasons. First, a receiver station may be able to recover a given data stream in scenarios in which the multiple data streams may not be spatially separable for various reasons. Second, MIMO detection with linear suppression (e.g., MMSE or zero-forcing) or non-linear suppression (e.g., successive interference cancellation) may be improved. Third, one or more data streams carrying correlated data may be randomized through the scrambling and descrambling, which may randomize interference and improve decoding performance. For example, a portion of a data stream may be repeated by the rate matching, and the data stream would then contain correlated data in the original portion and the repeated portion. The scrambling would randomize the correlated data. As another example, multiple UEs may send the same or similar data (e.g., a null frame or a Silence Insertion Description (SID) frame) in a MIMO transmission. The scrambling would randomize the data from these UEs.

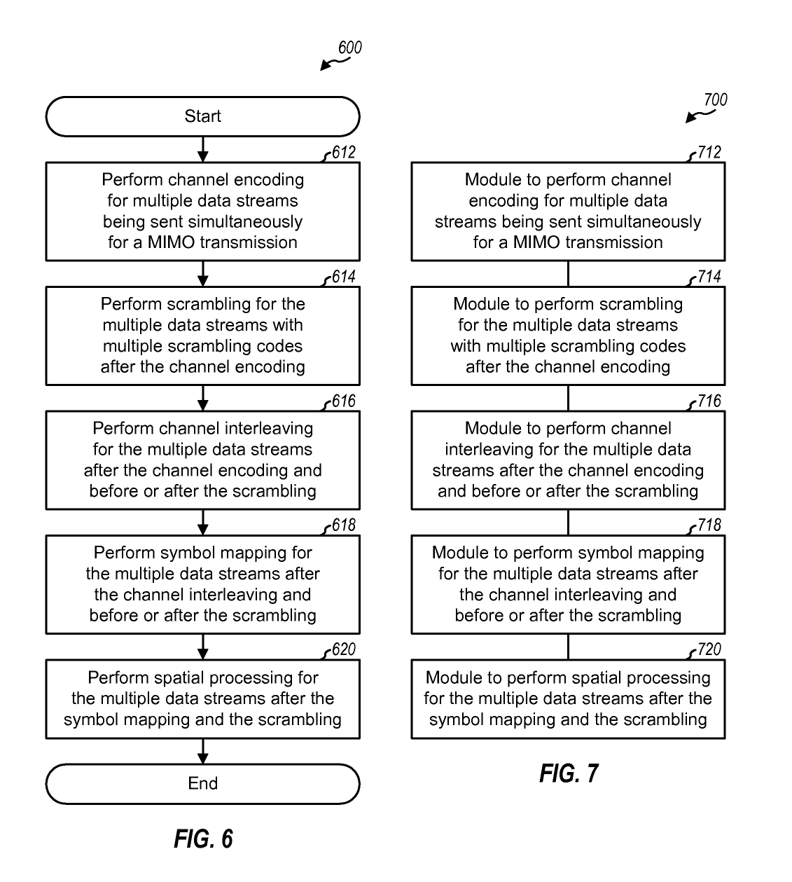

FIG. 6 shows a design of a process 600 for transmitting multiple data streams. Process 600 may be performed by a Node B, a UE, or some other entity. Channel encoding may be performed for multiple data streams being sent simultaneously for a MIMO transmission (block 612). The channel encoding may comprise FEC encoding and/or rate matching and may be performed independently for each data stream to obtain a corresponding encoded stream. Scrambling may be performed for the multiple data streams with multiple scrambling codes after the channel encoding (block 614). Each encoded stream may be scrambled with a different scrambling code to obtain a corresponding scrambled stream.

Channel interleaving may be performed for the multiple data streams after the channel encoding and either before or after the scrambling (block 616). The channel interleaving may also be omitted. Symbol mapping may be performed for the multiple data streams after the channel interleaving (if performed) and either before or after the scrambling (block 618). Spatial processing may be performed for the multiple data streams after the symbol mapping and the scrambling (block 620).

FIG. 7 shows a design of an apparatus 700 for transmitting multiple data streams. Apparatus 700 includes means for performing channel encoding for multiple data streams being sent simultaneously for a MIMO transmission (module 712), means for performing scrambling for the multiple data streams with multiple scrambling codes after the channel encoding (module 714), means for performing channel interleaving for the multiple data streams after the channel encoding and either before or after the scrambling (module 716), means for performing symbol mapping for the multiple data streams after the channel interleaving and either before or after the scrambling (module 718), and means for performing spatial processing for the multiple data streams after the symbol mapping and the scrambling (module 720).

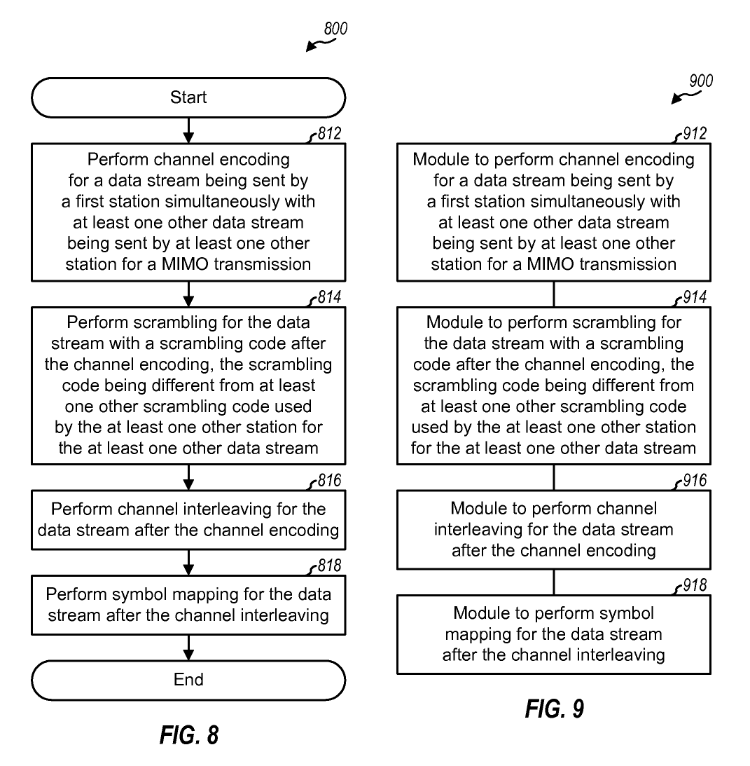

FIG. 8 shows a design of a process 800 for transmitting one data stream. Process 800 may be performed by a UE, a Node B, or some other entity. Channel encoding may be performed for a data stream being sent by a first station simultaneously with at least one other data stream being sent by at least one other station for a MIMO transmission (block 812). For block 812, FEC encoding and/or rate matching may be performed for the data stream to obtain an encoded stream. Scrambling may be performed for the data stream with a scrambling code after the channel encoding (block 814). The scrambling code may be different from at least one other scrambling code used by the at least one other station for the at least one other data stream. Channel interleaving may be performed for the data stream after the channel encoding (block 816). Symbol mapping may be performed for the data stream after the channel interleaving (block 818).

FIG. 9 shows a design of an apparatus 900 for transmitting one data stream. Apparatus 900 includes means for performing channel encoding for a data stream being sent by a first station simultaneously with at least one other data stream being sent by at least one other station for a MIMO transmission (module 912), means for performing scrambling for the data stream with a scrambling code after the channel encoding (module 914), means for performing channel interleaving for the data stream after the channel encoding (module 916), and means for performing symbol mapping for the data stream after the channel interleaving (module 918).

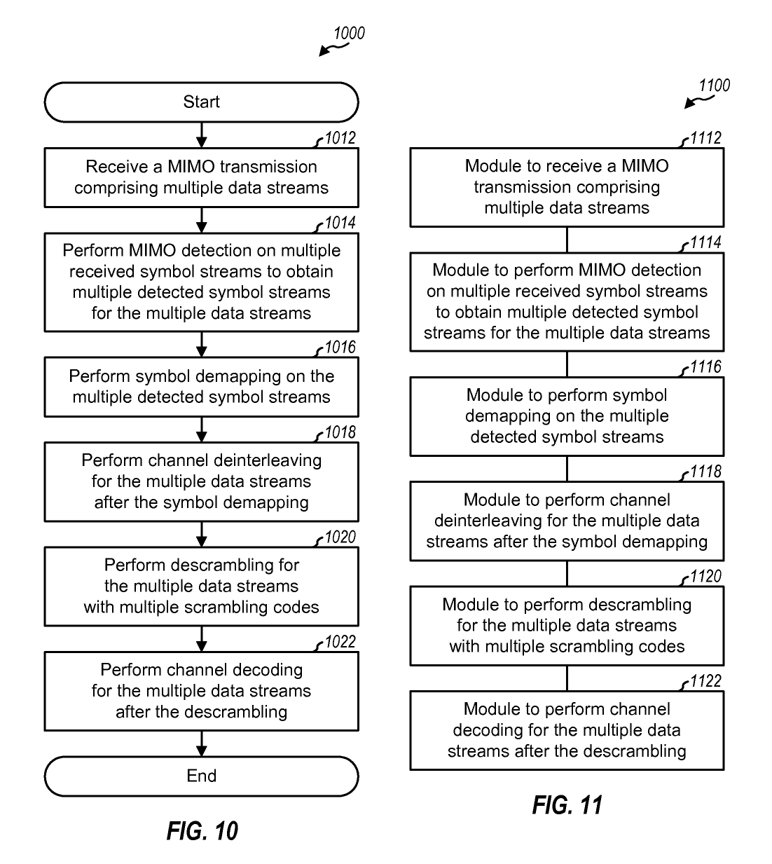

FIG. 10 shows a design of a process 1000 for receiving multiple data streams. Process 1000 may be performed by a Node B, a UE, or some other entity. A MIMO transmission comprising multiple data streams may be received (block 1012). MIMO detection may be performed on multiple received symbol streams to obtain multiple detected symbol streams for the multiple data streams (block 1014). Symbol demapping may be performed on the multiple detected symbol streams (block 1016). Channel deinterleaving may be performed for the multiple data streams after the symbol demapping (block 1018). Descrambling may be performed for the multiple data streams with multiple scrambling codes, e.g., for each data stream with a different scrambling code to obtain a corresponding descrambled stream (block 1020). Channel decoding may be performed for the multiple data streams after the descrambling (block 1022). For example, FEC decoding and/or de-rate matching may be performed on each descrambled stream to obtain a corresponding decoded data stream.

FIG. 11 shows a design of an apparatus 1100 for receiving multiple data streams. Apparatus 1100 includes means for receiving a MIMO transmission comprising multiple data streams (module 1112), means for performing MIMO detection on multiple received symbol streams to obtain multiple detected symbol streams for the multiple data streams (module 1114), means for performing symbol demapping on the multiple detected symbol streams (module 1116), means for performing channel deinterleaving for the multiple data streams after the symbol demapping (module 1118), means for performing descrambling for the multiple data streams with multiple scrambling codes (module 1120), and means for performing channel decoding for the multiple data streams after the descrambling (module 1122).

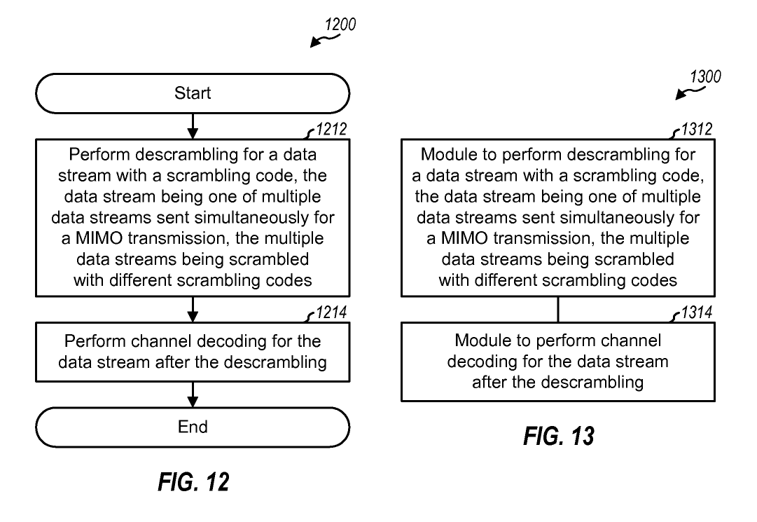

FIG. 12 shows a design of a process 1200 for receiving one data stream. Process 1200 may be performed by a Node B, a UE, or some other entity. Descrambling may be performed for a data stream with a scrambling code, with the data stream being one of multiple data streams sent simultaneously for a MIMO transmission (e.g., to multiple stations), and the multiple data streams being scrambled with different scrambling codes (block 1212). Channel decoding (e.g., FEC decoding and/or de-rate matching) may be performed for the data stream after the descrambling (block 1214). Symbol demapping may be performed for the data stream before the channel decoding. Channel deinterleaving may also be performed for the data stream after the symbol demapping and before the channel decoding.

FIG. 13 shows a design of an apparatus 1300 for receiving one data stream. Apparatus 1300 includes means for performing descrambling for a data stream with a scrambling code, with the data stream being one of multiple data streams sent simultaneously for a MIMO transmission, and the multiple data streams being scrambled with different scrambling codes (module 1312), and means for performing channel decoding for the data stream after the descrambling (module 1314).

The modules in FIGS. 7, 9, 11 and 13 may comprise processors, electronics devices, hardware devices, electronics components, logical circuits, memories, etc., or any combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus for wireless communication, comprising:
at least one processor configured to perform channel encoding for multiple data streams being sent simultaneously for a multiple-input multiple-output (MIMO) transmission, and to perform scrambling for the multiple data streams with multiple scrambling codes after the channel encoding; and
a memory coupled to the at least one processor.

2. The apparatus of claim 1, wherein the at least one processor is configured to obtain multiple encoded streams from the channel encoding for the multiple data streams, and to scramble each encoded stream with a different scrambling code to obtain a corresponding scrambled stream.

3. The apparatus of claim 1, wherein the at least one processor is configured to perform spatial processing for the multiple data streams after the scrambling.

4. The apparatus of claim 1, wherein the at least one processor is configured to perform channel interleaving for the multiple data streams after the channel encoding and before or after the scrambling.

5. The apparatus of claim 1, wherein the at least one processor is configured to perform symbol mapping for the multiple data streams after the channel encoding and before or after the scrambling.

6. The apparatus of claim 1, wherein the channel encoding comprises forward error correction (FEC) encoding, and wherein the at least one processor is configured to perform FEC encoding for each data stream to obtain a corresponding encoded stream.

7. The apparatus of claim 1, wherein the channel encoding comprises rate matching, and wherein the at least one processor is configured to perform rate matching for each data stream to obtain a corresponding encoded stream.

8. The apparatus of claim 1, wherein the channel encoding comprises forward error correction (FEC) encoding and rate matching, and wherein the at least one processor is configured to perform FEC encoding and rate matching for each data stream to obtain a corresponding encoded stream.

9. The apparatus of claim 1, wherein the multiple scrambling codes correspond to multiple pseudo-random number (PN) sequences.

10. A method for wireless communication, comprising:
performing channel encoding for multiple data streams being sent simultaneously for a multiple-input multiple-output (MIMO) transmission; and
performing scrambling for the multiple data streams with multiple scrambling codes after the channel encoding.

11. The method of claim 10, wherein the performing channel encoding comprises performing at least one of forward error correction (FEC) encoding and rate matching for each data stream to obtain a corresponding encoded stream.

12. The method of claim 11, wherein the performing scrambling comprises scrambling each encoded stream with a different scrambling code to obtain a corresponding scrambled stream.

13. The method of claim 10, further comprising:
performing symbol mapping for the multiple data streams after the channel encoding and before or after the scrambling; and
performing spatial processing for the multiple data streams after the symbol mapping and the scrambling.

14. An apparatus for wireless communication, comprising:
means for performing channel encoding for multiple data streams being sent simultaneously for a multiple-input multiple-output (MIMO) transmission; and
means for performing scrambling for the multiple data streams with multiple scrambling codes after the channel encoding.

15. The apparatus of claim 14, wherein the means for performing channel encoding comprises means for performing at least one of forward error correction (FEC) encoding and rate matching for each data stream to obtain a corresponding encoded stream.

16. The apparatus of claim 15, wherein the means for performing scrambling comprises means for scrambling each encoded stream with a different scrambling code to obtain a corresponding scrambled stream.

17. The apparatus of claim 14, further comprising:
means for performing symbol mapping for the multiple data streams after the channel encoding and before or after the scrambling; and
means for performing spatial processing for the multiple data streams after the symbol mapping and the scrambling.

18. A machine-readable medium comprising instructions which, when executed by a machine, cause the machine to perform operations including:
performing channel encoding for multiple data streams being sent simultaneously for a multiple-input multiple-output (MIMO) transmission; and
performing scrambling for the multiple data streams with multiple scrambling codes after the channel encoding.

19. An apparatus for wireless communication, comprising:
at least one processor configured to perform channel encoding for a data stream being sent by a first station simultaneously with at least one other data stream being sent by at least one other station for a multiple-input multiple-output (MIMO) transmission, and to perform scrambling for the data stream with a scrambling code after the channel encoding, the scrambling code being different from at least one other scrambling code used by the at least one other station for the at least one other data stream; and
a memory coupled to the at least one processor.

20. The apparatus of claim 19, wherein the at least one processor is configured to perform at least one of forward error correction (FEC) encoding and rate matching for the data stream to obtain an encoded stream, and to scramble the encoded stream with the scrambling code.

21. The apparatus of claim 19, wherein the at least one processor is configured to perform channel interleaving for the data stream after the channel encoding, and to perform symbol mapping for the data stream after the channel interleaving.

22. An apparatus for wireless communication, comprising:
at least one processor configured to receive a multiple-input multiple-output (MIMO) transmission comprising multiple data streams, to perform descrambling for the multiple data streams with multiple scrambling codes, and to perform channel decoding for the multiple data streams after the descrambling; and
a memory coupled to the at least one processor.

23. The apparatus of claim 22, wherein the at least one processor is configured to perform MIMO detection on multiple received symbol streams to obtain multiple detected symbol streams.

24. The apparatus of claim 22, wherein the at least one processor is configured to perform symbol demapping for the multiple data streams before the channel decoding and before or after the descrambling.

25. The apparatus of claim 22, wherein the at least one processor is configured to perform channel deinterleaving for the multiple data streams before the channel decoding and before or after the descrambling.

26. The apparatus of claim 22, wherein the at least one processor is configured to perform descrambling for each data stream with a different scrambling code to obtain a corresponding descrambled stream, and to obtain multiple descrambled streams from the descrambling for the multiple data streams.

27. The apparatus of claim 26, wherein the channel decoding comprises forward error correction (FEC) decoding, and wherein the at least one processor is configured to perform FEC decoding for each descrambled stream to obtain a corresponding decoded data stream.

28. The apparatus of claim 26, wherein the channel decoding comprises de-rate matching, and wherein the at least one processor is configured to perform de-rate matching for each descrambled stream to obtain a corresponding decoded data stream.

29. The apparatus of claim 26, wherein the channel decoding comprises forward error correction (FEC) decoding and de-rate matching, and wherein the at least one processor is configured to perform FEC decoding and de-rate matching for each descrambled stream to obtain a corresponding decoded data stream.

30. A method for wireless communication, comprising:
receiving a multiple-input multiple-output (MIMO) transmission comprising multiple data streams;
performing descrambling for the multiple data streams with multiple scrambling codes; and
performing channel decoding for the multiple data streams after the descrambling.

31. The method of claim 30, wherein the performing descrambling comprises performing descrambling for each data stream with a different scrambling code to obtain a corresponding descrambled stream.

32. The method of claim 31, wherein the performing channel decoding comprises performing at least one of forward error correction (FEC) decoding and de-rate matching for each descrambled stream to obtain a corresponding decoded data stream.

33. The method of claim 30, further comprising:
performing MIMO detection on multiple received symbol streams to obtain multiple detected symbol streams; and
performing symbol demapping on the multiple detected symbol streams prior to the descrambling.

34. An apparatus for wireless communication, comprising:
means for receiving a multiple-input multiple-output (MIMO) transmission comprising multiple data streams;
means for performing descrambling for the multiple data streams with multiple scrambling codes; and
means for performing channel decoding for the multiple data streams after the descrambling.

35. The apparatus of claim 34, wherein the means for performing descrambling comprises means for performing descrambling for each data stream with a different scrambling code to obtain a corresponding descrambled stream.

36. The apparatus of claim 35, wherein the means for performing channel decoding comprises means for performing at least one of forward error correction (FEC) decoding and de-rate matching for each descrambled stream to obtain a corresponding decoded data stream.

37. The apparatus of claim 34, further comprising:
means for performing MIMO detection on multiple received symbol streams to obtain multiple detected symbol streams; and
means for performing symbol demapping on the multiple detected symbol streams prior to the descrambling.

38. A machine-readable medium comprising instructions which, when executed by a machine, cause the machine to perform operations including:
receiving a multiple-input multiple-output (MIMO) transmission comprising multiple data streams;
performing descrambling for the multiple data streams with multiple scrambling codes; and
performing channel decoding for the multiple data streams after the descrambling.

39. An apparatus for wireless communication, comprising:
at least one processor configured to perform descrambling for a data stream with a scrambling code, and to perform channel decoding for the data stream after the descrambling, the data stream being one of multiple data streams sent simultaneously for a multiple-input multiple-output (MIMO) transmission, and the multiple data streams being scrambled with different scrambling codes; and
a memory coupled to the at least one processor.

40. The apparatus of claim 39, wherein the at least one processor is configured to perform at least one of forward error correction (FEC) decoding and de-rate matching for the data stream to obtain a decoded data stream.

41. The apparatus of claim 39, wherein the at least one processor is configured to perform symbol demapping for the data stream before the channel decoding, and to perform channel deinterleaving for the data stream after the symbol demapping and before the channel decoding.

42. The apparatus of claim 39, wherein the multiple data streams are sent to multiple stations.
